(19) United States
(12) Patent Application Publication
(10) Pub. No.: US 2012/0269999 A1
(43) Pub. Date: Oct. 25, 2012

(54) METHOD FOR PRODUCING CONTINUOUS-FIBER-REINFORCED MOLDED PARTS FROM THERMOPLASTIC PLASTIC, AND MOTOR VEHICLE MOLDED PART

(75) Inventors: Franz-Georg Kind, Konradsreuth (DE); Peter Michel, Hof (DE)

(73) Assignee: REHAU AG & Co., Rehau (DE)

(21) Appl. No.: 13/515,833

(22) PCT Filed: Dec. 21, 2010
(86) PCT No.: PCT/EP2010/007827

§ 371 Date: Jun. 14, 2012

(30) Foreign Application Priority Data
Dec. 21, 2009 (DE) 102009060027.2
Mar. 26, 2010 (DE) 102010013131.8

(51) Int. Cl. B29C 69/00; B29C 37/00; B29C 35/08; B32B 17/02; B32B 5/02; B32B 1/00; B32B 9/00; B29C 45/00; B62D 25/00

(52) U.S. Cl. 428/34.1; 264/331.11; 264/103; 264/328.14; 264/442; 264/482; 264/492; 296/187.01; 296/202; 428/292.1

(57) ABSTRACT

A method for producing continuous-fiber-reinforced molded parts from thermoplastic plastics. The method includes several steps. In a first step, preparing cut-to-size, substantially flat, unidirectionally fiber-reinforced mats are prepared with a thermoplastic matrix which at least partially surrounds the fibers. In a second step, the mats are transferred to a workpiece carrier which predetermines the rough contour of the molded part. In a third step, the mats are deposited and progressively built up on the workpiece carrier to form a three-dimensional preform such that the fiber orientation of the mats is adapted to the forces applied during the subsequent use of the molded part and to the load paths resulting therefrom within the molded part. In a fourth step, the mats are secured in place relative to each other during or after completion of the build-up of the perform. In a fifth step, the preform is heated up to or above the melting temperature of the thermoplastic matrix of the perform. In a sixth step, the three-dimensional preform is introduced into a mold tool forming the final contour of the molded part. In a seventh step, a homogenous pressure is set within the mold tool in order to ensure that the preform consolidates whilst simultaneously retaining the orientation of the fibers within the perform. In an eighth step, the resulting consolidated molded part is removed from the mold tool.

The present invention relates to a method for producing continuous-fiber-reinforced molded parts from thermoplastic plastics, and a motor vehicle molded part.

U.S. Pat. No. 7,235,149 B2 describes a method for producing motor vehicle molded parts from continuous-fiber-reinforced thermoplastic plastics. For this, the strip-shaped continuous-fiber-reinforced preform pieces are deposited on a flat surface at different angles relative to each other. The resulting flat sheet is subsequently preheated and formed by thermoforming. Depending on the wall thickness of the component, consolidating takes place in a separate or in the same thermoforming tool.

A disadvantage of the prior art is that due to necessary material overhang, the pressing process results in increased material waste. Furthermore, the 3D structure, generated only during the pressing process, and the associated forced orientation of the continuous fibers during the forming process represents merely a compromise between fiber orientation in the third dimension and the needed flow paths of the material. It is further a disadvantage that for achieving high degrees of deformation, an increased need for flowable material, i.e., for a thermoplastic matrix, is necessary, which inevitably results in increased component weight. Moreover, very high degrees of deformation cannot be implemented because otherwise fiber breakages occur within the continuous-fiber-reinforced molded part.

The object underlying the present invention is therefore to provide a method for producing continuous-fiber-reinforced molded parts from thermoplastic plastics which overcomes the disadvantages of the prior art.

This object is achieved according to the invention by a method for producing continuous-fiber-reinforced molded parts from thermoplastic plastics according to patent claim 1. Preferred embodiments of the method according to the invention are described in the dependent patent claims.

The method according to the invention comprises the following steps:
preparing cut-to-size, substantially flat, unidirectionally fiber-reinforced mats with a thermoplastic matrix which at least partially surrounds the fibers,
transferring the mats to a workpiece carrier which predetermines the rough contour of the molded part,
depositing and progressively building up the mats on the workpiece carrier to form a three-dimensional preform such that the fiber orientation of the mats is adapted to the forces applied during the subsequent use of the molded part and to the load paths resulting therefrom within the molded part,
securing the mats in place relative to each other during or after completion of the build-up of the preform,
heating the preform up to or above the melting temperature of the thermoplastic matrix of the preform,
introducing the three-dimensional preform into a mold tool forming the final contour of the molded part,
setting a homogenous pressure within the mold tool in order to ensure that the preform consolidates whilst simultaneously retaining the orientation of the fibers within the preform,
removing the consolidated molded part from the mold tool.

By preforming the unidirectionally fiber-reinforced mats into a three-dimensional perform, it is achieved in an advantageous manner according to the present invention that in the subsequent consolidation step, the molded part, in essence, does not have to undergo forming or flow processes. Advantageously, this requires therefore less flowable material, i.e., less thermoplastic matrix than in the case of the prior art. Due to the possibility of the inventive fiber orientation in the third dimension as well, it is additionally achieved that the forces acting on the molded part produced by means of the method according to the invention and the load paths resulting therefrom within the molded part can be optimally absorbed by the unidirectional fiber reinforcement.

Due to the optimization of the fiber orientation and the reduction of the proportion of flowable material, the result is therefore a molded part with a low weight and a small wall thickness compared to molded parts of the prior art, which result also offers great advantages in particular with regard to the limited installation space in vehicles. Due to the reduction of flowable material, the fiber content increases at the same time, which likewise contributes to the weight reduction and optimization of force absorption. The unidirectional, fiber-reinforced mats are preferably cut to size from unidirectional films. Compared to the prior art which discloses only strip-shaped structures, rework and the resulting material waste can be reduced through the specific pre-cut form of the mats. The fiber reinforcement of the mats is preferably formed by mineral fibers, in particular glass fibers, and/or carbon fibers, and/or aramid fibers, and/or polymeric fibers, and/or synthetic fibers and/or fibers of renewable raw materials.

It can be advantageous to secure the mats in place relative to each other by means of a welding process. Preferably, securing the mats in place is carried out by an ultrasonic welding and/or heated tool welding and/or laser welding method. Securing the pre-cuts of the mats in place relative to each other during or after completion of the build-up of the preform offers the advantage that the preform has considerably improved handling.

Moreover, textile-related methods, preferably needling and/or sewing, can be used for securing the mats in place relative to each other.

Preferably, the mats are at least partially preheated prior to depositing them onto the workpiece carrier in order to increase the flexibility of the mats. With the increased flexibility, it is advantageously achieved that said mats can better fit to the three-dimensional rough contour during depositing onto the workpiece carrier. Preferably, it is provided to heat the workpiece carrier in order to be able to maintain the flexibility of the mats.

Heating the preform or preheating the mats preferably takes place by convection heating and/or infrared radiation. More preferred, it takes place within a continuous convection and/or infrared furnace. For a component that already has a three-dimensional rough structure, heating through infrared radiation or by convection heating is an optimal method for uniformly heating the whole preform.

For transferring the mats and/or for introducing the preform, a robot system can be used. In particular, a tetrapod system (for example, a so-called FlexPicker™ from ABB) with an alternative, software-aided camera monitoring and control unit (image recognition) can be used. By using robot systems, an advantageous reduction of the processing time with respect to a manual method is achieved. In addition, by using robots, high reproducibility of the method can be achieved. This is a great advantage in particular with regard to a reproducible alignment of the mats relative to each other and the associated fiber orientation within the molded part.

Setting the homogenous pressure within the mold tool is preferably carried out by injecting a circumferential plastic keder (edge cord) on the edge side within the mold tool using an injection molding method. Moreover, setting the homogenous pressure within the mold tool can be carried out by additionally inserting GMT (glass-mat-reinforced thermoplastic) pieces, more preferably by means of a shot pot technique, or by inserting caulking strips into the mold tool, or by inserting a sealing film into the mold tool. Furthermore, within the context of the invention, the aforementioned possibilities can be used in any combination. By setting a homogenous pressure within the mold tool with the aforementioned possibilities, it is achieved that no uncontrolled flow processes of the thermoplastic material of the mats occur within the mold tool which would result in an unintended displacement of the fiber material embedded in the thermoplastic matrix. Moreover, due to the homogenous pressure within the mold tool, a uniform consolidation of the preform or the molded part is achieved. In particular by injecting a circumferential plastic keder on the edge side using an injection molding method, the edge region is also closed in an advantageous manner so that no fiber material can escape from the edge region, or no splaying of the inserted fiber material can occur.

Moreover, injection molding on the edge side requires only little additional material so that, in particular, the weight of the molded part is not significantly increased. Furthermore, by using an injection molding method, additional functions such as, e.g., clips, receptacles or fastening points can be injection-molded on the molded part.

Preferably, the workpiece carrier is moved on a conveyor section, wherein the individual process steps are carried out along said conveyor section. Thus, the workpiece carrier can be moved in an advantageous manner along a multiplicity of stations, in particular a multiplicity of robot stations, so as to further minimize the processing time until the molded part is finished.

Producing the molded part preferably takes place within a time interval of 20 to 120 seconds, more preferably within a time interval of 40 to 90 seconds and most preferably within time intervals of 55 to 65 seconds. The mentioned time intervals represent typical production times for molded parts of the automotive industry so that the method according to the invention can also be integrated within a production line of a motor vehicle.

Depositing the mats preferably takes place based on load paths within the molded part determined through finite element calculations of the molded part. The finite element calculation of the molded part allows adapting the orientation of the fibers specifically to these load paths. An adaptation of the method according to the invention can advantageously take place also in terms of the spatial orientation of the component.

Furthermore, part of the invention is a motor vehicle molded part wherein the molded part is built-up three-dimensionally in layers of at least two unidirectionally fiber-reinforced mats in such a manner that the fiber orientation is adapted to the forces applied during the subsequent use of the molded part and to the load paths resulting therefrom within the molded part.

Preferably, the motor vehicle molded part comprises a plastic keder. Said plastic keder is preferably circumferentially molded onto the edge side of the molded part. Molding the plastic keder onto the motor vehicle molded part is advantageously carried out by an injection process within an injection molding method or injection molding process.

Advantageously, the plastic keder is formed from a fiber-reinforced, more advantageously from a short fiber-reinforced, plastic. Preferably, the circumferential plastic keder on the edge side forms a closed structure. Thus, the structural stiffness of the molded part is increased in a particularly advantageous manner.

In an advantageous embodiment, the molded part has a cavity with at least one closed cross-section. The at least one closed cross-section can in particular be produced by an expansion body arranged within the preform. Within the preform, pressure is applied to the expansion body by means of a fluid so that said expansion body in connection with the walls of the mold tool forms the cavity within the motor vehicle molded part. Preferably, an elastic bladder, in particular a silicone bladder, is used as an expansion body. It is also conceivable here to work with a lost core which forms the cavity within the molded part. Further alternatives are gas and/or water injection methods.

It has proven to be advantageous that the fiber reinforcement of the mats or the molded part is formed by mineral fibers, in particular glass fiber, and/or carbon fibers, and/or aramid fibers, and/or polymeric fibers, and/or synthetic fibers and/or fibers from renewable raw materials.

Preferably, the motor vehicle molded part is formed as a support structure of a hatch or door that closes an opening of the motor vehicle, or as a structural part of the car body. More preferably, the molded part can be designed as part of the floor assembly of the motor vehicle or as a battery housing or a battery carrier. It is further within the context of the invention that the molded part is used as a structural profile in an aircraft. According to the invention, a motor vehicle includes any land vehicle, watercraft or aircraft.

Other possible uses of the technology according to the invention arise in the production of lightweight components and hollow-bodied components in the automotive sector, for industrial applications, in the machine tool industry, for sports equipment and in the construction sector.

### EXEMPLARY EMBODIMENTS

The invention is explained hereinafter by means of a drawing illustrating only an exemplary embodiment. In the figures, schematically:

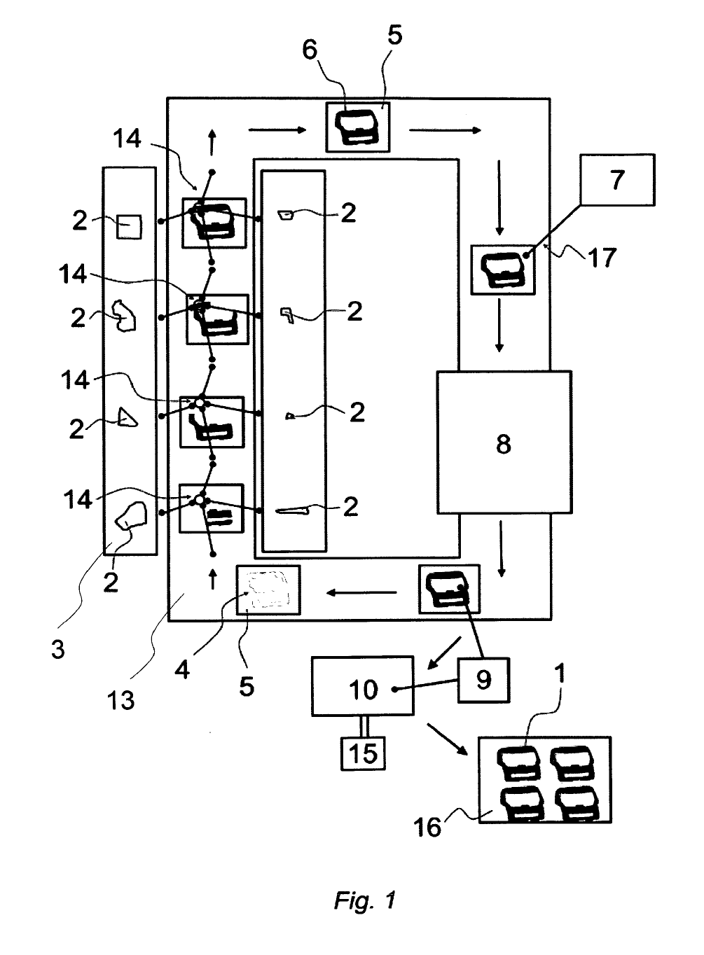

FIG. 1 shows an installation for carrying out the method according to the invention

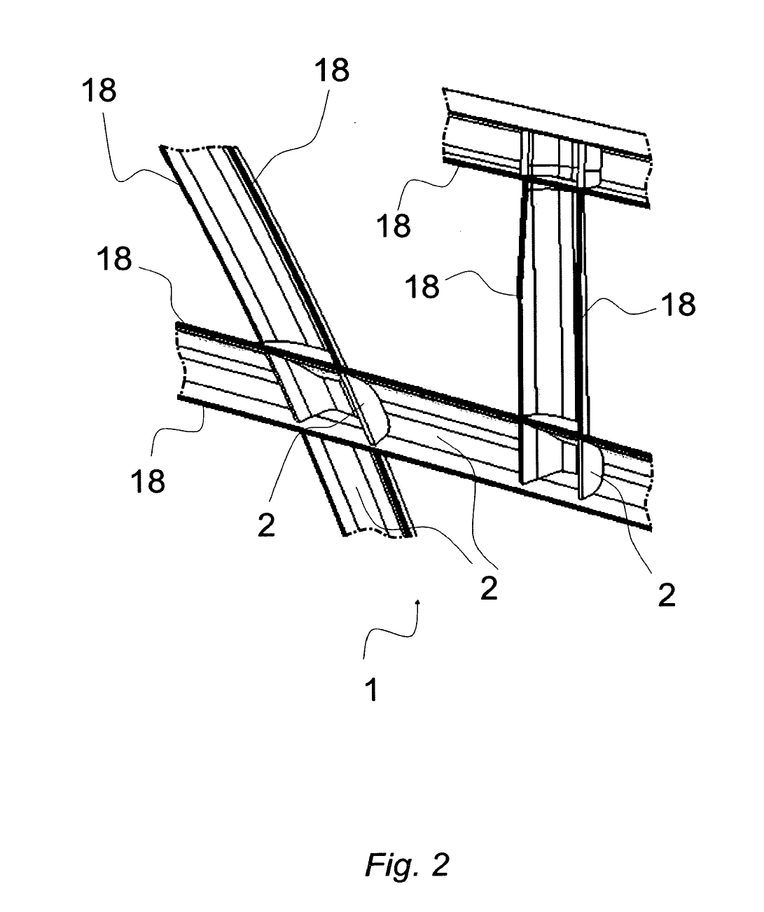

FIG. 2 shows a detailed view of a motor vehicle molded part with a plastic keder

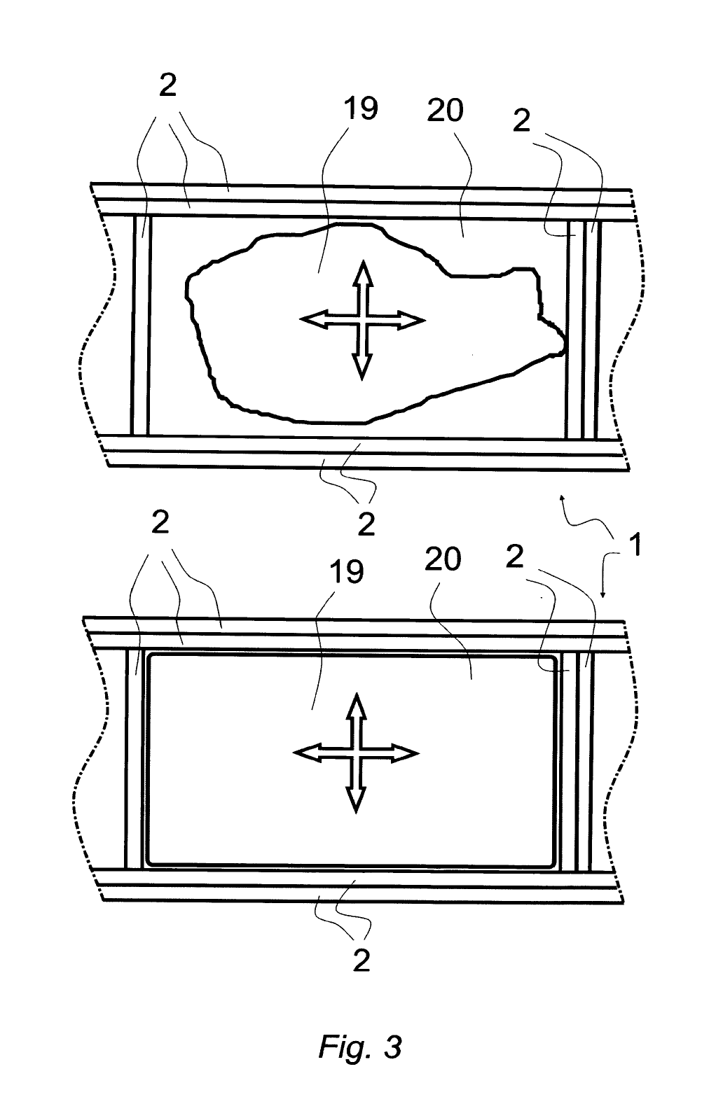

FIG. 3 shows another motor vehicle molded part according to the invention with a cavity

Identical or functionally identical elements in the figures are designated with the same reference numbers.

FIG. 1 shows an installation for implementing the method according to the invention for producing continuous-fiber-reinforced molded parts 1 from thermoplastic plastics. Cut-to-size, substantially flat, unidirectionally fiber-reinforced mats 2 with a thermoplastic matrix which at least partially surrounds the fibers are provided on a plurality of conveyor units 3. In this exemplary embodiment, the mats 2 are removed by the conveyor unit 3 from a magazine and are prepared at a predetermined position. Alternatively, the preparation of the mats can be carried out via a rolling and/or cutting unit (not illustrated here in detail). Prior to depositing onto a workpiece carrier 5, the mats 2 are at least partially preheated in order to increase the flexibility of the mats 2. Subsequently, the mats 2 are transferred to a workpiece carrier 5 which predetermines the rough contour 4 of the molded part 1. The workpiece carrier 5 itself is moved on a conveyor section 13. The cut-to-size mats 2 are deposited on the workpiece carrier 5 and are progressively built up to form a three-dimensional preform 6 such that the fiber orientation of the mats 2 is adapted to the forces applied during the subsequent use of the molded part and to the load paths resulting therefrom within the molded part 1. Transferring, depositing and building up the preform 6 is carried out by a plurality of robot stations or robot system 14 which are arranged along the conveyor section 13. Upon completion of the build-up of the preform 6, the mats 2 are secured in place relative to each other. Securing in place takes place by means of a laser welding installation 7, wherein laser optics (not illustrated in detail) is arranged at a further robot station 17.

Alternatively, securing the preform 6 in place relative to each other can take place already during the build-up of the mats 2 by means of textile-related methods. Subsequently, the preform 6 is heated in a continuous infrared furnace 8 above the melting temperature of the thermoplastic matrix of the preform 6. Alternatively, heating can also take place within a continuous convection furnace or in a mold tool 10 itself. Introducing the three-dimensional preform 6 in the mold tool 10 forming the final contour of the molded part 1 is carried out by means of a further robot station 9. Setting a homogenous pressure within the mold tool in order to ensure that the preform 6 consolidates whilst simultaneously retaining the orientation of the fibers takes place by injection-molding a circumferential plastic keder 18 (cf. FIG. 2) on the edge side of the preform 6. For this purpose, an injection molding unit 15 is provided which prepares adequately plasticized material, preferably fiber-reinforced thermoplastic material, and injects it with pressure into the mold tool 10. The consolidated molded part 1 is also removed by means of the robot station 9 from the molded tool 10 and fed to a storage unit 16.

FIG. 2 shows a detailed view of a motor vehicle molded part 1 with plastic keder 18 molded thereon. The molded part 1 is built up three-dimensionally in layers from at least two unidirectionally fiber-reinforced mats 2 in such a manner that the fiber orientation is adapted to the forces applied during the subsequent use of the molded part 1 and to the load paths resulting therefrom within the molded part 1. The plastic keder 18 is circumferentially molded onto the molded part 1 on the edge side thereof. Molding the plastic keder 18 onto the motor vehicle molded part 1 is carried out through an injection process within an injection molding method in the mold tool 10 of the motor vehicle molded part 1. Said plastic keder 18 is formed from a short fiber-reinforced plastic.

FIG. 3 shows a motor vehicle molded part 1 according to the invention with a cavity 20 which has at least one closed cross-section. The at least one closed cross-section is created by an expansion body 19 arranged within the preform 6. Within the preform 6, pressure (indicated with arrows) is applied to the expansion body 19 by means of a fluid so that said expansion body in connection with the walls of the mold tool forms the cavity 20 within the motor vehicle molded part 1.

As an expansion body 19, an elastic bladder, in particular a silicone bladder is used. As an alternative, it is possible to work with a lost core which forms the cavity 20 within the molded part.

1. A method for producing continuous-fiber-reinforced molded parts from thermoplastic plastics, comprising the following steps:
preparing cut-to-size, substantially flat, unidirectionally fiber-reinforced mats with a thermoplastic matrix which at least partially surrounds the fibers,
transferring the mats to a workpiece carrier which predetermines the rough contour of the molded part,
depositing and progressively building up the mats on the workpiece carrier to form a three-dimensional preform such that the fiber orientation of the mats is adapted to the forces applied during the subsequent use of the molded part and to the load paths resulting therefrom within the molded part,
securing the mats in place relative to each other during or after completion of the build-up of the preform,
heating the preform up to or above the melting temperature of the thermoplastic matrix of the preform,
introducing the three-dimensional preform into a mold tool forming the final contour of the molded part,
setting a homogenous pressure within the mold tool in order to ensure that the preform consolidates whilst simultaneously retaining the orientation of the fibers within the preform, and
removing the resulting consolidated molded part from the mold tool.

2. The method according to claim 1, wherein securing the mats in place relative to each other is carried out by a welding method.

3. The method according to claim 1, wherein securing the mats in place is carried out through textile-related methods.

4. The method according to claim 1, wherein prior to depositing onto the workpiece carrier, the mats are at least partially preheated in order to increase the flexibility of the mats.

5. The method according to claim 1, wherein heating the preform or preheating the mats is carried out by convection heating, preferably within a continuous convection furnace.

6. The method according to claim 1, wherein for transferring the mats and/or for introducing the preform, a robot system is used.

7. The method according to claim 1, wherein setting the homogenous pressure within the mold tool is carried out by injecting a circumferential plastic keder on the edge side within the mold tool using a method selected from one of a group of methods consisting of the injection molding method, by additionally inserting GMT pieces into the mold tool, by using a shot pot technique, by inserting caulking strips into the mold tool by inserting a sealing film into the mold tool.

8. The method according to claim 1, wherein the workpiece carrier is moved on a conveyor section and the individual process steps are carried out along the conveyor section.

9. The method according to claim 1, wherein producing the molded part is carried out within a time interval of 20 to 120 seconds.

10. A motor vehicle molded part, wherein the molded part is built up three-dimensionally in layers of at least two unidirectionally fiber-reinforced mats in such a manner that the fiber orientation is adapted to the forces applied during the subsequent use of the molded part and to the load paths resulting therefrom within the molded part.

11. The motor vehicle molded part according to claim 10, wherein a plastic keder is circumferentially molded, preferably injection molded, onto the edge side of molded part.

12. The motor vehicle molded part according to claim 11, wherein the plastic keder is formed from a fiber-reinforced plastic.

13. The motor vehicle molded part according to claim 1, wherein the molded part has a cavity with at least one closed cross-section.

14. The motor vehicle molded part according to claim 1, wherein the fiber reinforcement is formed by one of a group of mineral fibers consisting of glass and carbon fibers.

15. The motor vehicle molded part according to claim 1, wherein the molded part is designed as a support structure of a hatch or door that closes an opening of the motor vehicle, or as a structural part of the body of the motor vehicle.

16. The method according to claim 3, wherein the textile-related methods include needling and/or sewing.

17. The method according to claim 2, wherein the welding method is selected from one of a group of welding methods consisting of ultrasonic welding, heated tool welding, and laser welding.

18. The method according to claim 3, wherein the textile related method is needling or sewing.

19. The method according to claim 9, wherein producing the molded part is carried out within a time interval of 40 to 90 seconds.

20. The method according to claim 1, wherein heating the preform or preheating the mats is carried out by infrared radiation, preferably within a continuous infrared furnace.

21. The motor vehicle molded part according to claim 14, wherein the mineral fibers are selected from one of a group of fibers consisting of glass fibers and and carbon fibers.

22. The motor vehicle molded part according to claim 1, wherein the fiber reinforcement is formed by a group of fibers consisting of aramid fibers, polymeric fibers, and synthetic fibers.

23. The motor vehicle molded part according to claim 14, wherein the fibers are made from renewing raw materials.
